(19) United States
(12) Patent Application Publication
(10) Pub. No.: US 2013/0284203 A1
(43) Pub. Date: Oct. 31, 2013

(54) PLASMA SPRAY APPARATUS INTEGRATING WATER CLEANING

(71) Applicant: PROGRESSIVE SURFACE, INC., Grand Rapids, MI (US)

(72) Inventor: Kent VanEvery, Grand Rapids, MI (US)

(73) Assignee: PROGRESSIVE SURFACE, INC., Grand Rapids, MI (US)

(21) Appl. No.: 13/826,252

(22) Filed: Mar. 14, 2013

Related U.S. Application Data
(60) Provisional application No. 61/639,471, filed on Apr. 27, 2012.

(51) Int. Cl. B08B 3/02

(52) U.S. Cl. CPC B08B 3/026
USPC 134/1.1; 156/345.1

(57) ABSTRACT

An integrated apparatus and method comprises a plasma gun with a water supply, treatment fluid supply, and controls, the combination of which is adapted for directing a plume onto a surface of a three-dimensional part to treat the surface; and for controlling injection of water into the plume with the plume directed onto an adjacent surface to clean debris and undesired material from the adjacent surface; and for subsequently directing the plume (without water) onto the adjacent surface to treat the adjacent surface. The apparatus and method are particularly useful in suspension plasma spray systems, but are not believed to be limited to that.

This application claims benefit under 35 USC §119(e) of provisional Application No. 61/639,471 filed Apr. 27, 2012, entitled PLASMA SPRAY APPARATUS INTEGRATING WATER CLEANING, the entire contents of which are incorporated herein.

### BACKGROUND

The present invention relates to plasma spray apparatus, and more particularly relates to a plasma spray apparatus integrating water cleaning of contaminants and overspray.

Plasma spray coatings adhere to a substrate primarily by mechanical forces. Thus, for optimal coating performance, loose debris such as grit blasting residue remaining from surface preparation or overspray generated during a coating process should be removed from the substrate prior to applying a coating. Otherwise, the applied coating has poor adhesion and will spall or flake off.

One way in prior art for cleaning loosely adhered particulates off a substrate prior to applying a plasma spray coating is to direct a jet of compressed gas onto the substrate. A more aggressive method to achieve the aforementioned cleaning involves using dedicated blasting devices to launch solid media (e.g. grit carried by air, grit carried by water, or dry ice carried by air) onto the substrate surface. In the case of grit-blasting, coated areas adjacent to the region to be cleaned generally need to be masked or shielded from the grit, to prevent damage to the coating. Additionally, the grit-blasting process leaves dust particulates on the substrate surface that need to be removed prior to applying a coating. Compressed gas is often used for this removal.

None of the above techniques are performed with a plasma torch. Instead, separate equipment is typically used, resulting in additional capital expenditure for equipment, additional maintenance, and a less efficient process flow since the plasma torch/treating process must be shut off (or redirected) while separate equipment is used to clean loosely adhered particulates. It is noted that process efficiency, and in particular avoidance of process interruption, can be important in providing consistently and uniformly treated parts. For example, an efficient process flow will result in less cycle time per treated part, a more uniform treatment across the entire surface of the part, and avoidance of irregularities and quality problems in surface treatment caused by process interruptions and process restarts. In some existing processes, a person or robot may enter into a work area to clean loosely adhered particulates, which can result in possible introduction of contaminants and process inconsistencies.

A reason the plasma jet alone is not used to blow loosely adhered particulates off a substrate is because the heat from the plasma can partially melt these particulates, causing an increase in adhesion of the undesirable material to the substrate, making it more difficult to remove the undesirable material. Also, even though the adhesion of the undesirable material is increased, the adhering strength may still be much lower strength than is necessary for good coating adhesion. Also, the undesirable material is unlikely to be in the proper form (e.g. phase or morphology) for a good coating. Similarly, a plasma torch is not used to propel blasting media at a substrate because the media would melt and form a coating on the substrate rather than clean it. Notably, the temperatures within the plume exiting a plasma torch can easily be over 10,000 degrees Centigrade.

### SUMMARY OF THE PRESENT INVENTION

In one aspect of the present invention, a plasma spray surface treatment apparatus including a plasma gun constructed to generate a plume for treating a surface of a three-dimensional part, a water supply including water, and a water line for transferring the water from the water supply into the plume. The apparatus also includes a treatment fluid supply, a treatment fluid line for transferring the treatment fluid from the treatment fluid supply into the plume, and at least one control for controlling flow of the water and of the treatment fluid into the plume.

In a narrower aspect, the treatment fluid includes a suspension.

In another aspect of the present invention, an integrated method of plasma treating process comprises injecting water into a plume of a plasma gun and directing the plume onto a surface to clean debris and undesirable particles from the surface.

In a narrower aspect, the method includes directing the plume onto a three-dimensional part to treat the surface, and thereafter treating the surface with the plume.

In a narrower aspect, the method includes treating a portion of the surface with the plume before injecting the water, and thereafter directing the plume with the injected water onto an adjacent portion of the surface.

In a narrower form, the process includes using a thermal spray process to simultaneously coat and clean. This can be done for example, by injecting suspension into the plume top and injecting water under a significantly lower pressure into the plume bottom, wherein minimal interaction occurs between the injected species.

These and other aspects, objects, and features of the present invention will be understood and appreciated by those skilled in the art upon studying the following specification, claims, and appended drawings.

### BRIEF DESCRIPTION OF DRAWINGS

FIGS. 1a-1c are perspective schematic views of a plasma spray process, FIG. 1a showing a non-planar part prior to spraying a coating, FIG. 1b showing a part after spraying a central area and showing areas with loose overspray particulates (which would decrease coating adhesion when attempting to spray continuously from the upper to lower surface, resulting in flaking and spallation), and FIG. 1c showing a fully coated part in which the present innovative integrated water cleaning process was used prior to coating the lower (and upper) surfaces to remove overspray on the lower surfaces.

FIG. 2 is a schematic of a plasma spray system incorporating components for injecting water into a plasma plume to create an integrated cleaning step.

### DETAILED DESCRIPTION OF PREFERRED EMBODIMENTS

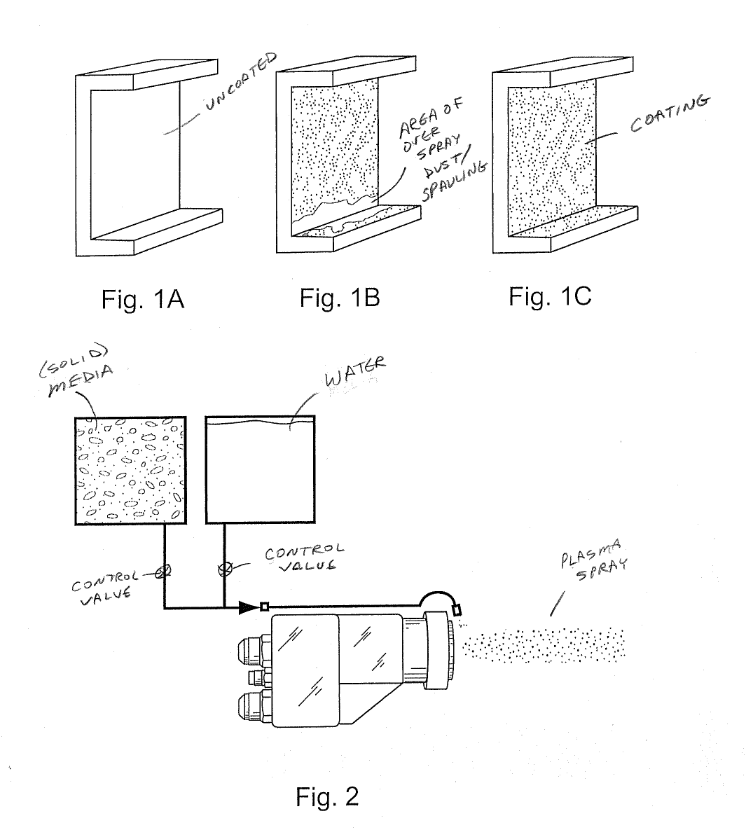

The present apparatus and method incorporating the present innovative technology of a liquid (e.g. water) injected into the plume of a thermal treatment process have been tested to effectively and efficiently clean debris and loose undesired material from a surface, thus improving treatment of the surface on a part. The cleaning is particularly useful in a suspension plasma spray (SPS) process for treating non-planar surfaces, such as where the part geometry is similar to that in FIG. 1a. However, it is believed that a scope of the present innovation is broader than just suspension plasma spray processes. Specifically, while treating a surface on the upper portion of the illustrated part, such as when applying a coating, a dust-like overspray material can be produced that lands on the adjacent lower (and upper) part surfaces. The coating applied to these lower surfaces then deposits as the overspray dust, which is not well adhered to the part. Consequently, the coating on the lower surfaces tends to spall, or flake off, the part during or immediately after spraying, or otherwise is insufficiently bonded, leaving portions of the part uncoated or unacceptably coated (FIG. 1b).

The present innovative technology uses an integrated liquid (preferably water) cleaning process as a means of removing the overspray debris. I believe this cleaning process is more effective and efficient than the most commonly used known method described in the background above. Additionally, the present innovative technology can be simply integrated with the typical thermal spray equipment and processes, including SPS thermal spray coating equipment, and does not require protecting the existing coating or treated surfaces during the overspray removal. As a result, by using this technology, a more efficient and less interrupted plasma spraying process is created, including one that incorporates a cleaning step performed between spraying the upper and lower portions of the part that removes the overspray, eliminating spallation (as shown in FIG. 1c). The present cleaning process is believed to be particularly useful for SPS processes, since coatings applied via SPS processes often generate some level of overspray which can deposit on surfaces adjacent a treated surface. However, it is contemplated that a scope of the present invention includes various liquids, including water, water-including liquids, and other non-contaminating liquids in combination, injected into a plume of a thermal spray treating process,

The present innovative technology includes injecting a liquid (e.g. water) into the plume of a plasma torch. My experimentation suggests that the interaction between the plasma and the water creates a stream of molecules and ions that impact and clean the substrate. Specifically, the impacts remove undesirable, loosely-adhered particulates on the substrate surface. Additionally, the heat in the stream can volatilize organic contaminates off the substrate surface. This result was surprising and unexpected given the high temperature of the plasma plume, as discussed below.

Testing indicates that in some circumstances it is possible to coat and clean simultaneously. For example, by injecting suspension into the plume top and injecting water under a significantly lower pressure into the plume bottom, minimal interaction occurs between the injected species. This arrangement allows for simultaneous processing, which offers even greater process efficiencies than separate steps of coating and cleaning as described above.

Specifically, the present innovative technology injects a liquid (e.g. water) into the plasma through a solid stream orifice located external to the plasma gun and orientated radial to the plasma flow, as shown in FIG. 2. In the illustrated embodiment, the orifice threads into a stainless steel tube mounted onto the face of the gun nozzle. Plastic tubing runs from the backside of the stainless steel tube to a pneumatically-actuated, normally-closed solenoid which in turn is connected to a water supply. When opened, the solenoid allows water to flow from a pressurized supply perpendicularly to the injection orifice. A separate tubing-solenoid combination also delivers suspension from a suspension treatment fluid supply for the SPS coating process to the injection orifice mounted on the plasma gun. As an example, one technique for using this innovative technology involves aiming the plasma gun away from the part being coated, stopping the suspension feed, and starting the liquid (water) feed. Once the suspension remaining in the line has been flushed through the orifice and only fresh liquid (water) is being injected into the plasma, the gun is positioned/aimed to clean the desired part surfaces. The rate and degree of cleaning have been observed to depend on the speed and number of times the gun passes over a surface. Additionally, the gun to surface separation distance and plasma parameters (e.g. temperature and speed) are expected to influence the effectiveness of this innovation.

The temperatures within a plume exiting a plasma torch can easily be over 10,000 degrees Centigrade. As a result of this very high temperature, general reasoning suggests that most liquids injected into the plasma would be quickly vaporized. For example in my testing, I noticed that, while using water to clean a component attached to a plasma torch, the resulting water stream entering the plasma caused the visible plume to approximately double in length. This increase suggested to me that the water was not simply being vaporized; but instead, some of the water was being accelerated with the plasma flow. Consequently, I tested this accelerated water method to determine if it could remove loosely adhered particulates off a coating substrate. I found that the innovative process provided additional advantages, such as the heat from the plasma leaving the cleaned surface dry and ready for coating deposition, and elimination of the need for a separate blasting machine/process to remove the loose particulates. I have never seen a plasma system or method integrating water injecting components for providing an integrated cleaning technique as described above. It is contemplated that additional liquids could be used other than just water, their composition depending on the functional and treatment requirements of parts.

It is contemplated that a scope of the present invention includes variations, as will be understood and realized by a skilled artisan upon reviewing the present disclosure. For example, the steps of injecting water into a plume of a plasma gun and directing the plume onto a surface to clean debris and undesirable particles from the surface can be done as separate steps or done simultaneously. Also, the process can be a repetitive one. For example, a machine/process could clean an upper area, clean a lower area, and spray the upper area and/or lower area to a portion of the desired thickness, and then repeat the entire process to build up the full coating thickness.

Also, as noted above, adherence problems can be caused by overspray. Nonetheless, it is noted that when feedstock used to make the coating is small (as is typically the case in SPS), this overspray can change the microstructure of the coating depositing on top of it. Specifically, the presence of overspray can increase the porosity in the coating applied over it. Therefore, it is contemplated that the present innovative technique and related process and equipment can also be intentionally used to modify the microstructure of the depositing coating under certain conditions.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A plasma spray surface treatment apparatus comprising:
a plasma gun constructed to generate a plume for treating a surface of a three-dimensional part;
a liquid supply including water;
a water line for transferring the water from the liquid supply into the plume;
a treatment fluid supply;
a treatment fluid line for transferring the treatment fluid from the treatment fluid supply into the plume; and
at least one control for controlling flow of the water and of the treatment fluid into the plume.

2. The apparatus of claim 1, wherein the treatment fluid includes a suspension.

3. An integrated method of plasma surface treating process comprising:
injecting water into a plume of a plasma gun and directing the plume onto a surface to clean debris and undesirable particles from the surface.

4. The method defined in claim 3, including directing the plume with water onto a three-dimensional part to clean the surface, and thereafter treating the surface with the plume without the water.

5. The method defined in claim 3, including treating a portion of the surface with the plume before injecting the water, and thereafter directing the plume with the injected water onto an adjacent portion of the surface to clean the adjacent surface.

6. The method of claim 3, wherein the treatment fluid includes a suspension.
